(19) United States
(12) Patent Application Publication
(10) Pub. No.: US 2017/0300825 A1
(43) Pub. Date: Oct. 19, 2017

(54) HIDDEN MARKOV MODEL FOR JAMMER BEHAVIOR PREDICTION

(71) Applicant: BAE SYSTEMS Information and Electronic Systems Integration Inc., Nashua, NH (US)

(72) Inventors: Joanne K. Como, Chichester, NH (US); Dianne E. Egnor, Catonsville, MD (US)

(21) Appl. No.: 15/359,778

(22) Filed: Nov. 23, 2016

Related U.S. Application Data
(60) Provisional application No. 62/259,380, filed on Nov. 24, 2015.

(51) Int. Cl. G06N 7/00; H04K 3/00; G06N 99/00

(52) U.S. Cl. CPC G06N 7/005; G06N 99/005; H04K 3/222

(57) ABSTRACT

Jammer behavior modeling utilizes two-layer hidden Markov models (HMMs) for identifying an interferer's plurality of modes and accumulating statistics on transitions between the interferer's plurality of modes for use in improved jammer characterization. The two-layer hidden Markov model characterizes jammer behavior by estimating time-varying but repetitive (mode-cycling) jammer behavior, providing estimates of future states for use by a strategy optimizer. Steps include receiving input data from an interferer; determining if models exist for describing the interferer's behavior; determining if a new model is needed; building a first layer HMM for each state of the interferer; building a second layer HMM using an output from the first layer HMM; and outputting the results from the first and second layer HMMs to a strategy optimizer to identify an interferer's plurality of modes and accumulate statistics on transitions between the interferer's plurality of modes for use in jammer mode prediction.

### RELATED APPLICATIONS

This application claims the benefit of U.S. Provisional Application No. 62/259,380 filed 24 Nov. 2015. This application is herein incorporated by reference in its entirety for all purposes.

### STATEMENT OF GOVERNMENT INTEREST

This invention was made with United States Government support under Contract No. FA8750-11-C-0189 awarded by the United States Air Force. The United States Government has certain rights in this invention.

### FIELD OF THE DISCLOSURE

Embodiments relate to the field of signal processing and more particularly, to predicting jammer behavior for improved jammer behavior prediction.

### BACKGROUND

Interference factors that affect military communications are increasing, not only in the capability and sophistication of jammers, but in the number and variety of interference sources. Static anti-jam techniques are not adequate for this complex and dynamic environment. Adaptive interference suppression approaches that can characterize emitter behavior and forecast possible future states are required so that the optimal mitigation strategy is selected.

What is needed is a method and system to identify an interferer's plurality of modes and accumulate statistics on transitions between an interferer's plurality of modes for modeling and predicting jammer behavior.

### SUMMARY

An embodiment provides a two-layer hidden Markov model (HMM) method of predicting jammer behavior comprising receiving input data from an interferer; determining if any models exist for describing an interferer's behavior; determining if a new model is needed; building a first layer HMM for each state of the interferer; building a second layer HMM using an output from the first layer HMM; and outputting results from the first layer HMM and the second layer HMM to a strategy optimizer which identifies an interferer's plurality of modes and accumulates statistics on transitions between the interferer's plurality of modes for use in jammer behavior prediction, wherein the predictions are made by the strategy optimizer to select from a library of mitigation strategies the optimal strategy to be used against a next predicted mode of the jammer. In embodiments the input data comprises higher order statistics; a binary detection map; a likelihood vector for current observation features; a statefile; and a timestamp. In other embodiments, the two-layer hidden Markov models are built by an interference recognizer. In subsequent embodiments the two-layer hidden Markov models are built by an interference recognizer with one hidden Markov model per emitter. For additional embodiments, upon HMM startup, a model is created for a first mode using a first data window; and subsequent windows are split into frames, each of which is compared to existing models using a two-stage forward HMM. In another embodiment, jammer modes are not previously known, and a number of required states is estimated by calculating an average silhouette of k-means clustering. For a following embodiment k-means clustering is performed on data with increasing number of clusters. In subsequent embodiments, for each k-means result, an average silhouette value is calculated and compared to prior values. In additional embodiments the models are built in an unsupervised fashion, whereby no prior training is performed and all models are built during run-time. Included embodiments comprise looping through each subspace. In yet further embodiments the HMM input data comprises a vector of binary frequency detections; and time and frequency higher order statistics for each sample interval. In related embodiments frequency maps are binary and higher order statistics are quantized and stacked upon detections to create completely binary input vectors. For further embodiments a first stage finds an ideal path through each of the HMMs given the input data using a Jaccard coefficient similarity metric of

$$J ( y , Y ) = \frac{\vert y ⋂ Y \vert}{\vert y ⋃ Y \vert} .$$

In ensuing embodiments, if a threshold for a first stage is not met, a second stage finds an ideal path using a Bernoulli log-like metric of

$${\sum }_{i = 1}^{n} {Y}_{i} log ( {p}_{i} ) + ( 1 - {Y}_{i} ) log ( 1 - {p}_{i} ) .$$

Another embodiment provides a two-layer hidden Markov model (HMM) system for predicting jammer behavior comprising inputting data; looping through for each subspace; stacking inputs; determining if a model exists; if the model does not exist, then train new model, if the model does exist, then divide inputs into frames; performing HMM forward algorithm processing for each frame and each jammer mode model; grouping consecutive frames and remove small gaps; looping through labeled data; if label equals 0, then perform expectation maximization algorithm; if is first 0 in window, then train a new model; if is not first 0 in window, then perform the HMM forward algorithm processing for each frame and each jammer mode model; after training the new model, process histogram obsvec inputs and update transition matrices; and outputting predicted jammer states, whereby a most likely next jammer state is predicted using a current HMM state along with HMM transition and transition duration matrices. For yet further embodiments, the HMM forward algorithm processing for each frame and each jammer mode model comprises calculating a HMM forward algorithm Jaccard metric; if the HMM forward algorithm Jaccard metric is greater than thresh1, then a frame state label equals max; if the HMM forward algorithm Jaccard metric is not greater than the thresh1, then calculate a HMM forward algorithm Bernoulli log likelihood metric; if the HMM forward algorithm Bernoulli log likelihood metric is greater than thresh2, then the frame state label equals max; if the HMM forward algorithm Bernoulli log likelihood metric is not greater than thresh2, then the frame state label equals 0. For more embodiments, the looping through labeled data step comprises if a loop of label equals 0, and a first 0 in window, then train a new model; if the loop of label is not equal to 0, then update model computing an expectation maximization algorithm; if the loop of label equals 0, and is not the first 0 in window, then perform the HMM forward algorithm processing for each frame and each jammer mode model. In continued embodiments training a new model comprises a silhouette of Kmeans to find a number of states; initializing Bernoulli probabilities; and performing an expectation maximization algorithm. For additional embodiments, the histogram obsvec inputs and update transition matrices comprises calculating obsvec feature statistics; calculating a HMM transition matrix; and calculating a HMM transition durations matrix.

A yet further embodiment provides a non-transitory computer-readable storage medium including instructions that are configured, when executed by a computing system, to develop a two-layer hidden Markov model (HMM), the method comprising receiving input data from an interferer; determining if any models exist for describing an interferer's behavior; determining if a new model is needed; building a first layer HMM for each state of the interferer; building a second layer HMM using an output from the first layer HMM; and outputting results from the first layer HMM and the second layer HMM to a strategy optimizer to identify an interferer's plurality of modes and accumulate statistics on transitions between the interferer's plurality of modes for use in jammer detection.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating the Hidden Markov Model (HMM) for jammer behavior prediction in accordance with an embodiment.

FIG. 2 is a flow chart of the HMM for jammer behavior prediction system configured in accordance with an embodiment.

FIG. 3 shows comparisons of results from first layer of HMM using different approaches in accordance with an embodiment.

FIG. 4 shows HMM jammer prediction for a periodic jammer in accordance with an embodiment.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The invention is susceptible of many embodiments. What follows is illustrative, but not exhaustive, of the scope of the invention.

In certain embodiments of the jammer detection system, signal models simulate the signal source without having to have the source available. For embodiments, jammer behavior is modeled using two-layer hidden Markov models built by an interference recognizer, with one hidden Markov model per emitter. The HMM is trained on one or more time/frequency detection maps to identify a jammer's modes, and then accumulates statistics on transitions between the modes. The models are built in an unsupervised fashion; in that no prior training is performed and all models are built during run-time.

In certain embodiments, the first of the two layers consists of HMMs for each of the modes or states of the emitter. These modes can contain states specific to that mode, with observations and transition probabilities modeled by an HMM. The HMM inputs consist of a vector of binary frequency detections along with time and frequency higher order statistics for each sample interval. The frequency maps are binary, where the higher order statistics are quantized and stacked upon the detections to create completely binary input vectors. In certain embodiments, the observations are modeled using Bernoulli distributions due to the binary nature of the inputs.

Typically when building an HMM, the number of states must be known ahead of time. However, since the jammer modes are not previously known, the number of required states is estimated by calculating the average silhouette of k-means clustering. The silhouette gives a measure of the closeness of points in a cluster compared to neighboring clusters with larger values indicating more separation between clusters. In certain embodiments, k-means clustering is performed on the data with increasing number of clusters. For each k-means result, the average silhouette value is calculated and compared to the prior values. When a maximum is reached, the number of states to produce the maximum is used in building the HMM.

In embodiments, upon HMM startup, since no mode exists, a model is created for the first mode using the first data window. Subsequent windows are split into frames, each of which is compared to existing models using a two-stage forward HMM. The first stage finds an ideal path through each of the HMMs given the input data using a Jaccard coefficient similarity metric:

$$J ( y , Y ) = \frac{\vert y ⋂ Y \vert}{\vert y ⋃ Y \vert}$$

where y is a vector containing the means of the observations for a state and Y is the current observation vector. If the threshold for the first stage is not met, the second stage finds an ideal path using a Bernoulli log-like metric:

$${\sum }_{i = 1}^{n} {Y}_{i} log ( {p}_{i} ) + ( 1 - {Y}_{i} ) log ( 1 - {p}_{i} )$$

where Yᵢ is the current observation at the iₜₕ location in the observation vector and pᵢ is the probability of a 1 at the observation location.

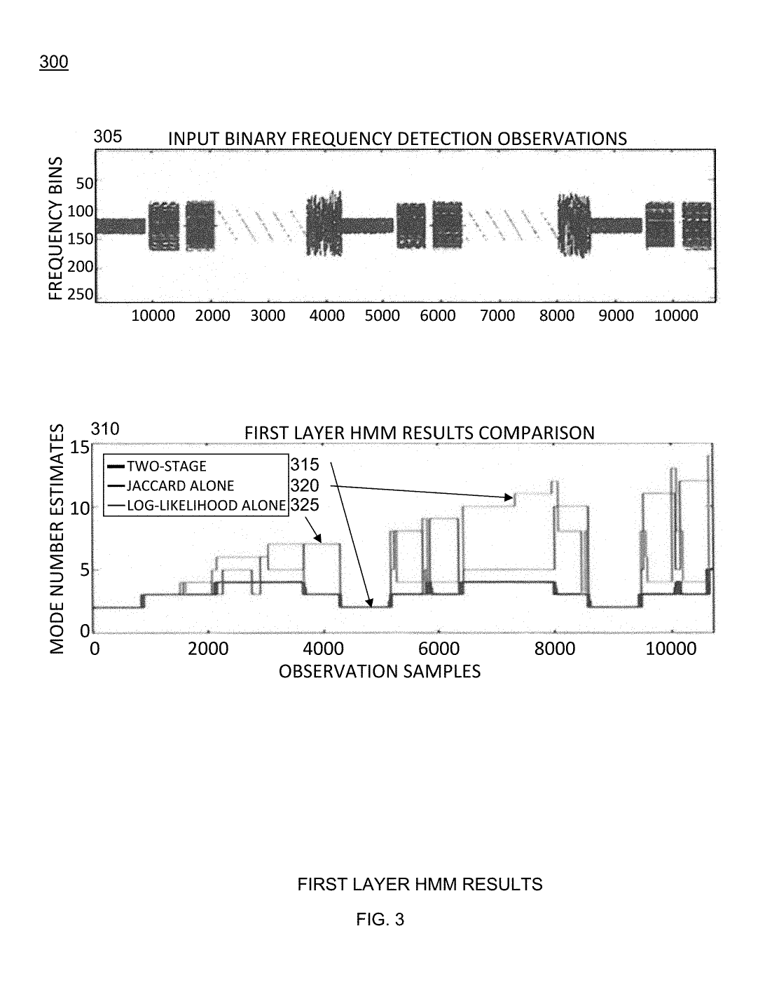

In certain embodiments of the jammer detection system, when the ideal path through any of the current models exceeds either threshold, the maximum result is chosen as the matching model, and the model is retained with the addition of this new data. When neither threshold is met for longer than a single frame, a new model is added. This two-stage algorithm yields improved performance over a single HMM with either of the similarity metrics alone as shown in FIG. 3 which compares the results from the first layer of the HMM using different approaches.

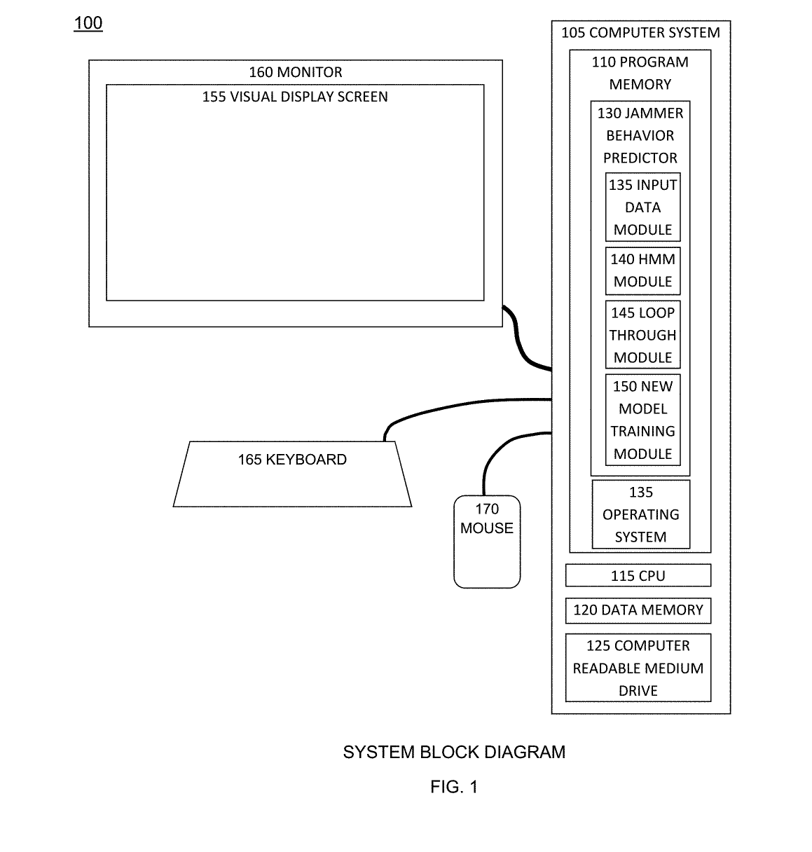

FIG. 1 is a block diagram 100 illustrating the HMM for jammer behavior prediction. Jammer behavior prediction system 100 comprises computer system 105 comprising program memory 110; controller/processor unit 115; data memory 120; and computer readable medium drive 125. Program memory 110 comprises jammer behavior predictor module 130 and operating system platform 135. Jammer behavior predictor module 130 comprises input data module 135, HMM forward algorithm processing module for each frame and each jammer model 140, loop through labeled data module 145, and new model training module 150. Computer system 105, according to the present example, comprises a controller/processor 135, which processes instructions, performs calculations, and manages the flow of information through computer system 105. Additionally, controller/processor unit 115 is communicatively coupled with program memory 110. Operating system platform 135 manages resources, such as the data stored in data memory 120, the scheduling of tasks, and processes the operation of the jammer behavior predictor 130 in program memory 110. Operating system platform 135 also manages a graphical display interface which displays information via visual display screen 155 included in computer monitor 160, a user input interface that receives inputs from keyboard 165 and mouse 170, and communication network interfaces (not shown) for communicating with a network link (not shown). Additionally, operating system platform 135 also manages many other basic tasks of computer system 105 in a manner well known to those of ordinary skill in the art.

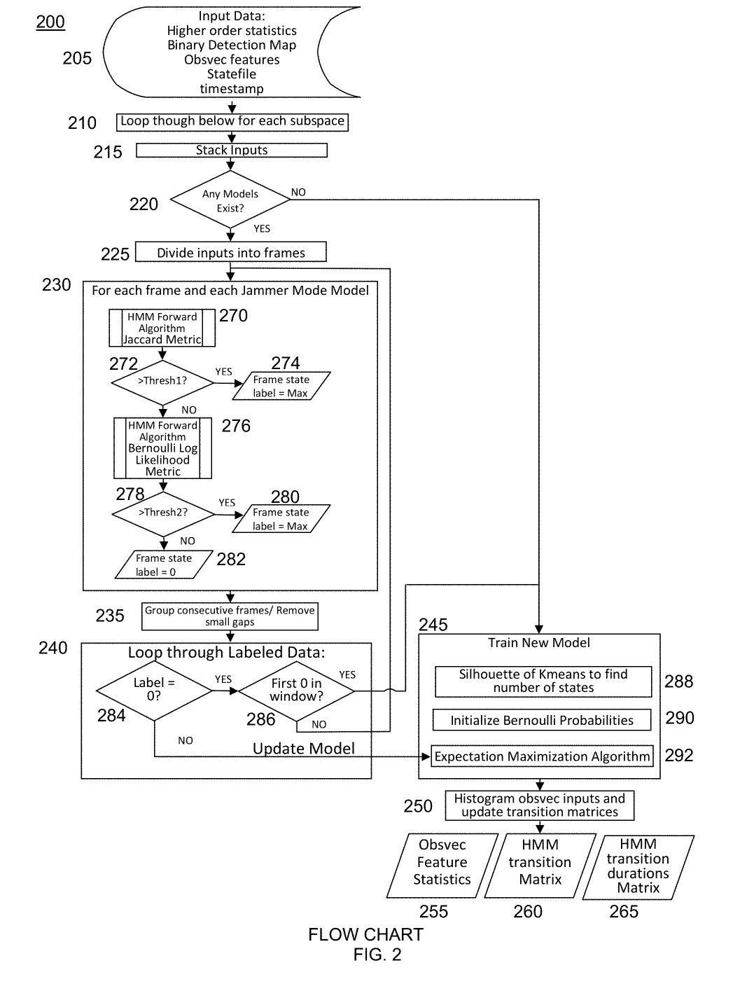

FIG. 2 is a flow chart 200 of one embodiment of the HMM for jammer behavior prediction system. More particularly, the embodiment determines whether any jammer behavior models exist, and if not, trains a new model as discussed herein. In certain embodiments, if models are detected then the frames associated with the new model are combined and statistics for the new jammer mode are collected to build the second layer of the hidden Markov model.

Specific steps comprise inputting data (Higher Order Statistics, binary detection map, obsvec (likelihood vector of several emitter observables for the current observation) features, statefile, and timestamp) 205; loop through for each subspace 210; stack inputs 215; determine if any models exist? 220; if no, then go to train new model 245, if yes, then divide inputs into frames 225; HMM forward algorithm processing for each frame and each jammer mode model 230; group consecutive frames/remove small gaps 235; loop through labeled data 240; train new model 245; histogram obsvec inputs and update transition matrices 250; obsvec feature statistics 255; and HMM transition matrix 260; HMM transition durations matrix 265. The HMM transition matrices along with the obsvec feature statistics are used by a strategy optimizer for prediction of the next jammer mode and selection of the best mitigation strategy. HMM forward algorithm processing for each frame and each jammer mode model 230 comprises HMM forward algorithm Jaccard metric 270; is greater than thresh1? 272; if yes, then frame state label =max 274; if no, then go to HMM forward algorithm Bernoulli log likelihood metric 276; is greater than thresh2? 278; if yes, then frame state label=max 280; if no, then frame state label=0 282. Loop through labeled data step 240 comprises loop of label=0? 284; if yes, then go to first 0 in window? 286; if label=0 is no, then go to update model to expectation maximization algorithm 292; if first 0 in window? 286 is yes, then go to train new model 245; if first 0 in window? 286 is no, then go to HMM forward algorithm processing for each frame and each jammer mode model 230. Train new model 245 comprises silhouette of k-means to find number of states 288; initialize Bernoulli probabilities 290; and expectation maximization algorithm 292.

Embodiments work in an unsupervised fashion, such that no prior training is performed and all jammer behavior models are built during run-time. Lower level models (first layer of HMM) representing the various jammer modes are built first as discussed herein 245, the higher level models representing jammer behavior (second layer of HMM) are built using statistics of the features, transitions, and durations observed while the jammer is cycling through these modes 255, 260, 265.

The input data consists of Higher Order Statistics, a binary detection map (frequency vs. time binary frequency detections), obsvec features (likelihood vector of several emitter observables for the current observation), a statefile containing current HMM state information, and timestamp 205. The inputs are read in for each subspace 210 and then the higher order statistics are quantized and stacked on top of the binary detection map 215 and used as input features. These features are then divided into frames 220. Upon startup, since no models exist, the first jammer mode model will be built using the initial input data frame 245. Subsequent data frames will be compared to existing models 230. If no match is found, the frame is labeled with a zero, to indicate no model exists 282. If a match is found, the frame is labeled with its matching model number 274, 280. At the completion of this labeling, consecutive frames containing the same model label are combined, with small gaps of different labels removed 235. The models are then updated to incorporate the new data 292. For frames labeled as zero, indicating that no model currently exists, they are not combined. For the first zero label a new model is built and added to the models against which subsequent zero labeled frames are compared 286, 245. This comparison is repeated for all zero labeled frames until each is labeled with a model number 230. These newly labeled frames are then combined where consecutive frames of the same label exist 235.

Steps for comparison of input data frames to existing models are done as a two stage process where an HMM forward algorithm is performed using a Jaccard metric 270, followed by another HMM forward algorithm using a Bernoulli log likelihood metric 276. If either of these tests exceeds their given threshold, the frame is labeled with the model number that yielded the maximum result. If neither threshold is exceeded, the frame is labeled with a zero, indicating that no model currently exists that is a good match to the data frame.

When a new model is to be trained, the steps include: find number of states required for HMM using a silhouette of Kmeans 288, initialize the Bernoulli probabilities 290, and then perform an Expectation Maximization algorithm to determine the model parameters 292.

After each new jammer mode model is trained, a histogram of the obsvec inputs is created and the transition matrices are updated 250. This step provides the features for the second level HMM, obsvec feature statistics 255; HMM transition matrix 260; HMM transition durations matrix 265. The HMM transition matrices along with the obsvec feature statistics are used by a strategy optimizer for prediction of the next jammer mode and selection of the best mitigation strategy.

FIG. 3 presents comparisons of embodiment results 300 from the first layer of HMM using different approaches. These are Input Binary Frequency Detection Observations 305, and First Layer HMM Results Comparison 310. First Layer HMM Results Comparison 310 depicts two-stage results 315, Jaccard alone results 320, and log-likelihood alone results 325. More particularly, the results for this example show the HMM successfully discriminating between three of four states that are being cycled through. The two states where the HMM does not discriminate are very similar in that they occupy a similar detection space and would therefore be handled by the optimizer with a similar strategy.

In certain embodiments, the second layer of the HMM builds transition matrices for the emitter modes based on the observed outputs of the first layer. Two transition matrices built: one transition matrix containing the probabilities of transitioning between modes and a second transition matrix containing a history of durations observed in each mode given the prior mode. The frequency maps in FIG. 3 show an example of some of the observables associated with each of the modes, which are also construed by the second layer. These transition matrices and observation histograms are output to the Strategy Optimizer.

In embodiments, the Strategy Optimizer calculates the set of possible future states for a given time in the near future. It performs this by using a recursive computation starting from the HMM current state (which is assumed to be known with certainty). It recursively traverses a graph of states based on the transition probabilities and durations to arrive at the most likely future jammer mode to be mitigated. It can then use the obsvec emitter observables along with other data it has collected regarding the effectiveness of different strategies against particular modes to select the optimal mitigation strategy for a time in the near future. This enables a communications system to stay one step ahead of the jammer.

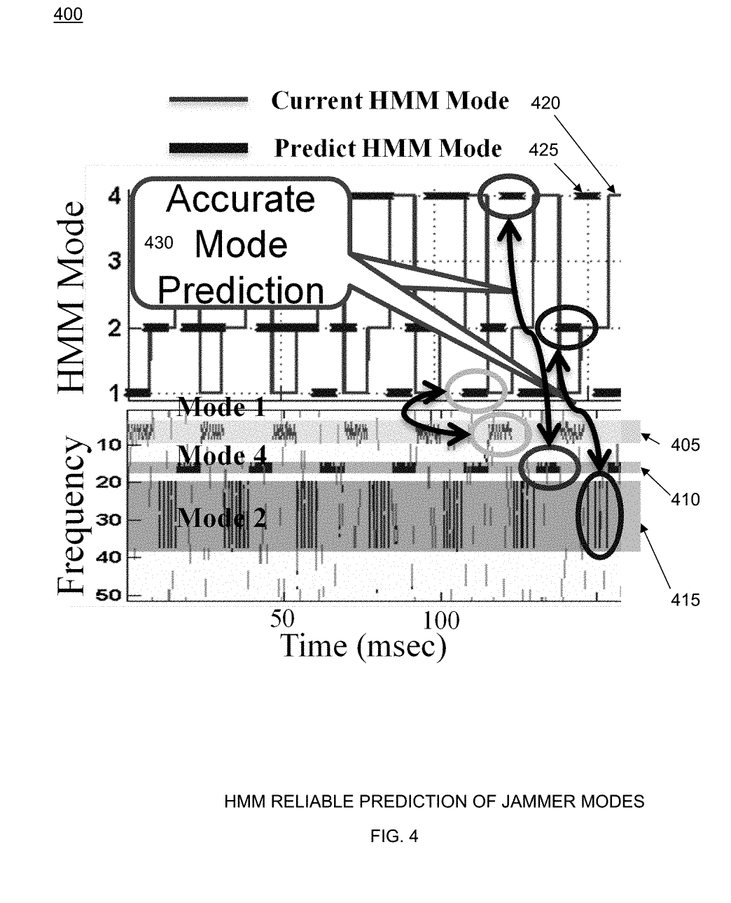

FIG. 4 shows the ability of the HMM to predict jammer behavior for a periodic jammer 400. Bottom spectrogram shows a jammer cycling through three modes (three bands Mode 1 405, Mode 4 410, and Mode 2 415 highlighting frequency bands). The top figure shows the modes of the jammer as estimated by the HMM (current mode 420 & predicted mode 425). Comparison of the top and bottom FIGS. 430 shows that after approximately 100 msec, the HMM reliably predicts the current and predicted modes of the jammer.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A two-layer hidden Markov model (HMM) method of predicting jammer behavior comprising:
receiving input data from an interferer;
determining if any models exist for describing an interferer's behavior;
determining if a new model is needed;
building a first layer HMM for each state of said interferer;
building a second layer HMM using an output from said first layer HMM; and
outputting results from said first layer HMM and said second layer HMM to a strategy optimizer which identifies an interferer's plurality of modes and accumulates statistics on transitions between said interferer's plurality of modes for use in jammer behavior prediction, wherein said predictions are made by said strategy optimizer to select from a library of mitigation strategies the optimal strategy to be used against a next predicted mode of said jammer.

2. The method of claim 1, wherein said input data comprises:
higher order statistics;
a binary detection map;
a likelihood vector for current observation features;
a statefile; and
a timestamp.

3. The method of claim 1, wherein said two-layer hidden Markov models are built by an interference recognizer.

4. The method of claim 1, wherein said two-layer hidden Markov models are built by an interference recognizer with one hidden Markov model per emitter.

5. The method of claim 1 wherein upon HMM startup, a model is created for a first mode using a first data window; and
subsequent windows are split into frames, each of which is compared to existing models using a two-stage forward HMM.

6. The method of claim 1 wherein jammer modes are not previously known, and a number of required states is estimated by calculating an average silhouette of k-means clustering.

7. The method of claim 1 wherein k-means clustering is performed on data with increasing number of clusters.

8. The method of claim 7, wherein for each k-means result, an average silhouette value is calculated and compared to prior values.

9. The method of claim 1 wherein said models are built in an unsupervised fashion, whereby no prior training is performed and all models are built during run-time.

10. The method of claim 1 comprising looping through each subspace.

11. The method of claim 1, wherein said HMM input data comprises:
a vector of binary frequency detections; and
time and frequency higher order statistics for each sample interval.

12. The method of claim 1, wherein frequency maps are binary and higher order statistics are quantized and stacked upon detections to create completely binary input vectors.

13. The method of claim 1 wherein a first stage finds an ideal path through each of said HMMs given said input data using a Jaccard coefficient similarity metric of
$$J ( y , Y ) = \frac{\vert y ⋂ Y \vert}{\vert y ⋃ Y \vert} .$$

14. The method of claim 1, wherein if a threshold for a first stage is not met, a second stage finds an ideal path using a Bernoulli log-like metric of
$${\sum }_{i = 1}^{n} {Y}_{i} log ( {p}_{i} ) + ( 1 - {Y}_{i} ) log ( 1 - {p}_{i} ) .$$

15. A two-layer hidden Markov model (HMM) system for predicting jammer behavior comprising:
inputting data;
looping through for each subspace;
stacking inputs;
determining if a model exists;
if said model does not exist, then train new model,
if said model does exist, then divide inputs into frames;
performing HMM forward algorithm processing for each frame and each jammer mode model;
grouping consecutive frames and remove small gaps;
looping through labeled data;
if label equals 0, then perform expectation maximization algorithm;
if is first 0 in window, then train a new model;
if is not first 0 in window, then perform said HMM forward algorithm processing for each frame and each jammer mode model;
after training said new model, process histogram obsvec inputs and update transition matrices; and
outputting predicted jammer states, whereby a most likely next jammer state is predicted using a current HMM state along with HMM transition and transition duration matrices.

16. The system of claim 15, wherein said HMM forward algorithm processing for each frame and each jammer mode model comprises:
calculating a HMM forward algorithm Jaccard metric;
if said HMM forward algorithm Jaccard metric is greater than thresh1, then a frame state label equals max;
if said HMM forward algorithm Jaccard metric is not greater than said thresh1, then calculate a HMM forward algorithm Bernoulli log likelihood metric;
if said HMM forward algorithm Bernoulli log likelihood metric is greater than thresh2, then said frame state label equals max;
if said HMM forward algorithm Bernoulli log likelihood metric is not greater than thresh2, then said frame state label equals 0.

17. The system of claim 15, wherein said looping through labeled data step comprises:
if a loop of label equals 0, and a first 0 in window, then train a new model;
if said loop of label is not equal to 0, then update model computing an expectation maximization algorithm;
if said loop of label equals 0, and is not said first 0 in window, then perform said HMM forward algorithm processing for each frame and each jammer mode model.

18. The system of claim 15, wherein said train new model comprises:
a silhouette of Kmeans to find a number of states;
initializing Bernoulli probabilities; and
performing an expectation maximization algorithm.

19. The system of claim 15, wherein said histogram obsvec inputs and update transition matrices comprises:
calculating obsvec feature statistics;
calculating a HMM transition matrix; and
calculating a HMM transition durations matrix.

20. A non-transitory computer-readable storage medium including instructions that are configured, when executed by a computing system, to develop a two-layer hidden Markov model (HMM), the method comprising:
receiving input data from an interferer;
determining if any models exist for describing an interferer's behavior;
determining if a new model is needed;
building a first layer HMM for each state of said interferer;
building a second layer HMM using an output from said first layer to HMM; and
outputting results from said first layer HMM and said second layer HMM to a strategy optimizer to identify an interferer's plurality of modes and accumulate statistics on transitions between said interferer's plurality of modes for use in jammer detection.
